(19) United States
(12) Patent Application Publication
(10) Pub. No.: US 2017/0109661 A1
(43) Pub. Date: Apr. 20, 2017

(54) Reservation System

(71) Applicant: John H. Bergman, Carrollton, TX (US)

(72) Inventor: John H. Bergman, Carrollton, TX (US)

(21) Appl. No.: 15/299,014

(22) Filed: Oct. 20, 2016

Related U.S. Application Data
(60) Provisional application No. 62/244,109, filed on Oct. 20, 2015.

(51) Int. Cl. G06Q 10/02; H04W 4/12; G06Q 20/10; G06Q 10/10; H04L 29/08; G06Q 30/02

(52) U.S. Cl. CPC G06Q 10/02; H04L 67/02; G06Q 30/0277; G06Q 20/102; G06Q 30/0282; G06Q 10/1093; H04W 4/12

(57) ABSTRACT

A computer system useful in a reservation system that is configured to generate web pages offering activity related reservations and facilitation for a wide variety of goods and services that user may want relating to an activity or outing. The computer system generates web pages to advertise for service providers and to receive service provider data applications, advertise credentialed service providers and services, publish available schedules for service providers and activities, list related services, rentals, and licenses The computer system is operable to schedule activities and track reservations for activities, make related reservations for related services and rentals and process license applications and submit associated fees.

### FIELD OF THE DISCLOSURE

The present disclosure relates generally to a system and device configured to coordinate reservations for loosely related activities.

### BACKGROUND

Online reservation systems are known. If an individual seeks to reserve a flight, he or she can go to a service that coordinates flights, hotels, and automotive rentals. Alternatively, the individual can go straight to the website of the airline, the hotel or the car company.

For other activities, however, reservation management is more complex. With respect to outdoor activity guides, such as hunting and fishing guides, reservations are normally directly with the guide via email or by phone in response to a personal recommendation or advertisement. There is no service that coordinates reservations for such guides or the services offered by the guides. A similar problem exists in many other areas such as coaching, tutoring, hiking, bicycling, etc.

### BRIEF DESCRIPTION OF THE DRAWINGS

FIG. 1 is a functional network diagram of a network configured to schedule and facilitate purchasing of loosely or indirectly related goods and services according to one embodiment.

FIG. 2 is a functional block diagram of a computing and communication system useful in a reservation system that is configured to generate web pages offering activity related reservations and facilitation.

FIG. 3 is a flowchart that illustrates a method according to one embodiment that includes enrolling providers.

FIG. 4 is a method for generating webpage's for related services according to one embodiment. The method commences with the reservation server 12 receiving a user request for an activity (120).

FIG. 5 is a flowchart that illustrates a method for capturing user feedback according to one embodiment.

FIG. 6 is a flowchart that illustrates a method for updating a social media website according to one embodiment.

FIG. 7 is a flowchart that illustrates a method according to one embodiment utilizing text messaging to make reservations.

FIG. 8 is a signal flow diagram that illustrates a method according to one embodiment.

FIG. 9 is a functional block diagram of a processor system that represents a hardware configuration that may be modified by one of skill in the art to implement any element, module or block described herein this specification.

### DETAILED DESCRIPTION

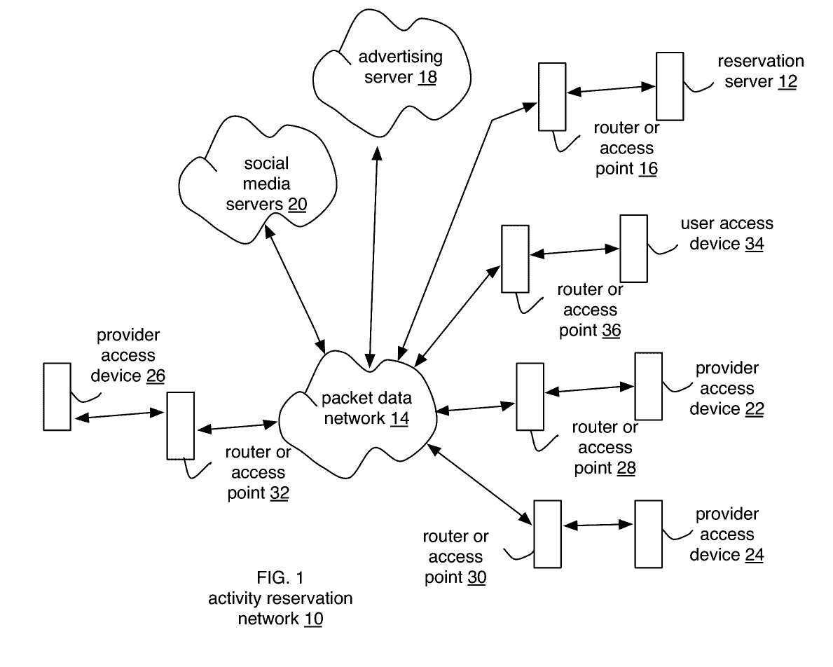

FIG. 1 is a functional network diagram of a network configured to schedule and facilitate purchasing of loosely or indirectly related goods and services according to one embodiment. An activity reservation network 10 includes a reservation server 12 that communicates with a packet data network 14 via a router or access point 16. Network 10 also includes one or more advertising servers 18 and one or more social media servers 20 that also are configured to communicate over packet data network 14. Additionally, network 10 includes provider access devices 22-26 that access packet data network via router or access points 28-32. Additionally, network 10 includes a plurality of user access devices 34 that access the packet data network 14 via router or access points 36.

In operation, advertising server 18 is configured to generate web pages via packet data network 14 to advertise or promote the activity reservation system or network. This includes advertising particular service providers and suppliers of goods for loosely related goods and services. Advertising server 18 also is configured to generate web pages to advertise for service providers and goods suppliers to populate its advertisements that are intended for users. Accordingly, as providers respond to the advertisements via their provider access devices 22-26, the responses are delivered to reservation server 12 via router or access point 16 for processing. The processing by server 12 includes validating the credentials (credentialing) for the providers that respond to ensure that they meet specified requirements including having adequate references for quality, safety, professionalism, licensing (including verification), and insurance levels required either by statute or organization including the reservation processing company.

When a user replies to an advertisement web page generated by advertising server 18, any reply, selection, request or order is delivered to reservation server 12. Reservation server 12, upon receiving the reply, selection, request or order, generates one of a plurality of web pages for display to the user. For example, if the user indicates that a fishing guide is desired, reservation server 12 generates a web page for display to the user containing, for example, a list of dates for the user to select a date. The selected dates are then delivered to reservation server 12. In response to the selected dates, reservation server 12 generates a list of available guides and locations for the user to select. Alternatively, if the user prefers to pick a guide first (e.g., a particular guide is desired), reservation server 12 generates a list of available dates and times. Once a user has selected a guide, a date and a time for the activity, reservation server places a hold on that particular guide's schedule for the desired date and time. Once the user subsequently makes a partial or full payment, reservation server 12 completes the reservation and blocks that time and date on its own reservation calendar and generates a message to the selected activity guide for his or her planning purposes.

In addition to all of the scheduling related activities, reservation server 12 is further configured to generate additional pages for display to the user that correspond to loosely related goods and services. For example, while the user has requested, for example, a fishing guide, the user may also want to consider a hunting guide for a different day/time. Moreover, even completely unrelated (or very loosely related) services can be promoted or displayed as selectable options. For example, a hunter's spouse may want spa services while the hunter is out hunting or fishing. Accordingly, the reservation server generates web pages to promote or allow easy selection of unrelated services. Other services that the reservation server 12 makes selectable may include cooking services (to cook and serve the wildlife caught or killed), lodging services, laundry services, grocery shopping services, alternative activity services including but not limited to skiing guides, hunting guides, fishing guides, boating, hiking guides, horseback riding guides, scuba diving guides, snowmobiling guides, cross country skiing guides, ATV guides, whitewater rafting guides/services, bicycling guides, sight seeing and camping guides.

Additionally, reservation server generates web pages that correspond more closely to the activities selected by the user. For example, for hunting, reservation server includes in its memory a list of all related requirements and generates corresponding web pages including information and options that the user may not be aware of. More specifically, for example, some areas require by law that ammunition be purchased locally for hunting. Accordingly, reservation server includes logic and data stored within its memory to provide options for purchasing and delivering ammunition to the user for the hunting activity. Additionally, many activities require licensing. Accordingly, reservation server generates web pages to allow the user to apply for the appropriate licenses on line for subsequent approval and issuance. Based on the user selections, reservation server 12 also is configured to generate pages that correspond to payment processing for the selected goods, services, licenses, etc.

In many instances, reservation server 12 may generate a web page to display related options as described above or related data. It should be understood, however, that other alternatives for displaying options and data may readily be implemented and still be within scope of the disclosed embodiments. For example, one alternative approach would be for reservation server 12 to produce raw data to the user device wherein the user device generates a display that includes the data. Another alternative approach would be for reservation server 12 to generate a report or image with data, etc. for display on the user terminal. Additionally, in yet another alternative, another server for another service provider may link into reservation server 12 to retrieve data, information, etc. In such a scenario, reservation server 12 may respond to produce the data or information in a form that the remote server or application or device can receive and display the data according to display logic within the remote server, application or device. Accordingly, all references herein to reservation server generating a web page to display a particular response should be understood to include these alternative options.

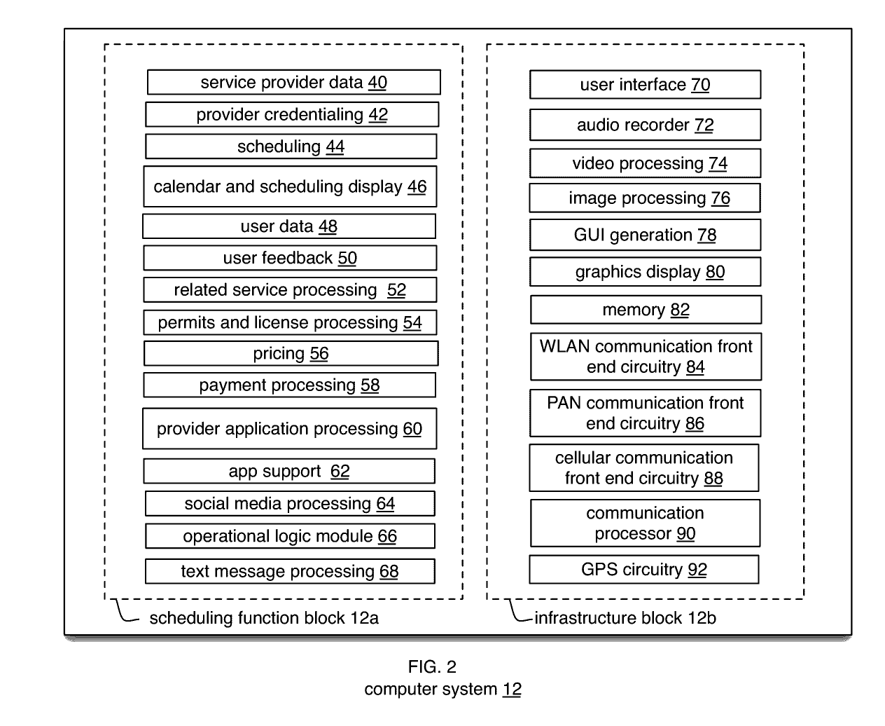

FIG. 2 is a functional block diagram of a computing and communication system useful in a reservation system that is configured to generate web pages offering activity related reservations and facilitation. The reservation server 12 includes logic and is configured to arrange data and computer instructions within its memory to logically define functional blocks or routines or data stores to support operations according to the described embodiments. In functional terms, reservation server is configured to includes a service provider credentialing block 12 to process server provider credentials and to determine whether to accept or reject a service provider application to provide associated services promoted or advertised by reservations server 12, including:
a service provider data block 40 for storing reservation provider application data, services data, and feedback data;
a provider credentialing block 42 which compares provider application data services data and feedback data to specified criteria to determine whether a provider may be accepted for services or whether a provider should be removed from a list of accepted service and goods providers;
a scheduling block 44 to maintain scheduling and availability data and to maintain reservations relating to users and activity guides or service providers;
a calendar and scheduling display block 46 to generate corresponding GUIs, images, graphics, symbols and data corresponding to scheduling information;
a user data block 48 storing user application data, user preferences, and biographical information and payment information and prior user feedback data;
a user feedback processing block 50 for prompting the user to provide feedback regarding the goods or services that the user purchased, enjoyed, or used and for processing the user feedback data to, for example, update advertising information or provider information as well as provider writings and for delivering the process data to various other blocks such as provider credentialing block 42 and service provider data block 40 as well as to external servers such as advertising server 18;
a related service processing block 52 for identifying tightly related, loosely related, and indirectly related goods and services and for delivering the related goods and services information for display to the user;
a permits and license processing block 54 for prompting a user to enter required information according to the permit or license that is being sought as well as providing necessary information to the user including cost information;
a pricing block 56 for maintaining a list of prices for all goods and services as well as any required handling fees, up charges, etc. and for delivering relevant pricing information for display to the user on a webpage or other form;
a payment processing block 58 for totaling the prices identified by pricing block 56 for the goods, services, permits and license requests made by the user;
a provider application processing block 60 for interacting with a provider seeking to apply to become an approved provider;
and application support block 62 for interacting with a provider access device user access device the packet data network 14 to install a related application in the provider or user access device to support the reservation related processing according to the various embodiments;
a social media processing block 64 for receiving media content in the form of audio, pictures and videos from a user or provider access device and for correlating the media content to a scheduled activity and for delivering the media content to specified end points including the advertising server 18, user access device 34, the provider access devices such as provider access devices 22-26 and social media servers 20 (e.g., Facebook™);
an operational logic module 66 for coordinating communications and interactions between the various blocks of computer system 12 not specified within the individual blocks;
a text message processing block 68 for interacting with a user access device or provider access device via text messages for delivering options thereto and receiving responses from there;
a user interface 70;
an audio recorder 72;
a video processing block 74;
and image processing block 76;
a GUI generation block 78;
a graphics display 80;
a memory 82;
a wireless local area network (WLAN) communication front-end circuitry 84;
a personal area network (PAN) communication front-end circuitry 86;
cellular communication front-end circuitry 88;
a communication processor 90; and
GPS circuitry 92.

It should be noted that blocks 40-68 are grouped together as scheduling function blocks 12a while blocks 70-92 are listed as infrastructure blocks 12b. Generally, the blocks grouped together in 12a are blocks that relate to the reservation processing logic while the blocks grouped together and shown as infrastructure blocks 12b are blocks let relate to hardware functionality that support the operations of the scheduling function blocks 12a.

Each of the described blocks define logic of the computer system that may be implemented in a variety of ways including a dedicated circuit configured to perform the described functions, state logic, or a processor with a memory block that contains the computer instructions that define the described logic blocks.

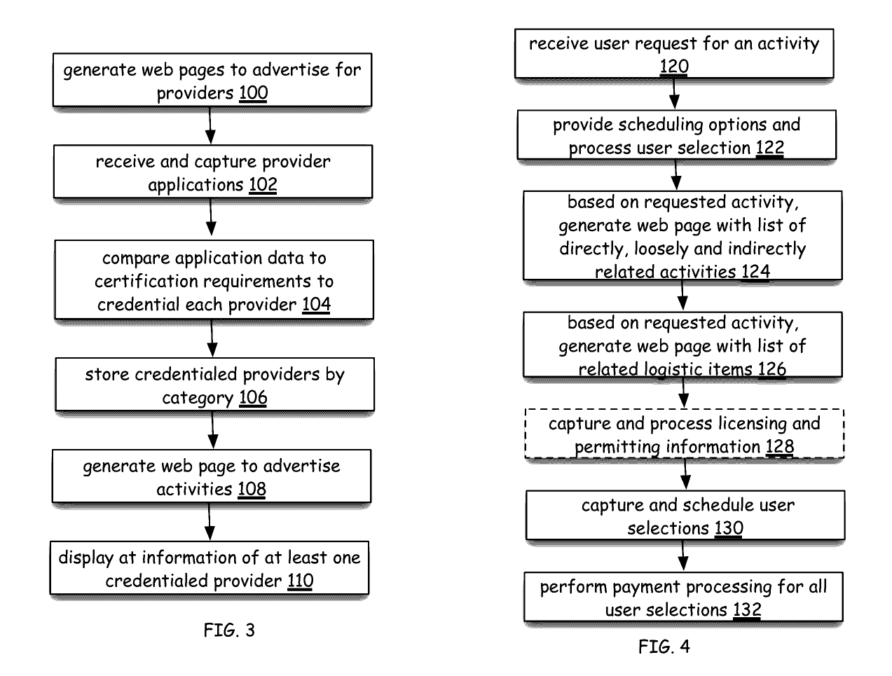

FIG. 3 is a flowchart that illustrates a method according to one embodiment that includes enrolling providers. The method commences with a server, for example, a reservation server 12 or an advertising server 18, generating webpage's to advertise for providers (100). Generating webpage's is meant to be interpreted in a broad manner as defined herein. For example, generating webpage's may include delivering data directly to a provider access device or delivering data to a remote server that populates its own webpage that is delivered to the provider access device. Thereafter, the method includes receiving and capturing provider applications (102). Thereafter, the method includes comparing application data to certification requirements to credential each provider (104). Thereafter, the method includes storing credentialed providers by category (106). Once a plurality of providers has been credentialed, the method includes generating webpage's to advertise activities (108). Again, the webpage's that are generated may be generated either by advertising server 18 or reservation server 12. Finally, based on a user response via a user access device, the method includes displaying information of at least one credentialed provider (110). This step may include transmitting data to an application that is resident on the user access device or it may include generating a webpage that may only be viewed by the user. Alternatively, this step can also include generating an image or screenshot that is delivered to the user access device.

FIG. 4 is a method for generating webpage's for related services according to one embodiment. The method commences with the reservation server 12 receiving a user request for an activity (120). Thereafter, the method includes the reservation server providing scheduling options and processing user selections (122). For example, providing these scheduling options may be in the form of a graphical user interface, a webpage that is generated for the user, or data that is transmitted to the user access device for display on the user device terminal or screen. Thereafter, the method includes, based on the requested activity, generating a webpage with a list of closely related, loosely related, and indirectly related activities for user selection (124). Thereafter, the method includes, based on receiving requested activity from the user, generating a webpage or data with a list of related logistic items (126). Thereafter, the method includes the optional step of capturing and processing licensing and permitting information (128). Thereafter the method includes capturing and scheduling user selections (130) and performing payment processing for all user selections (132). Performing payment processing includes adding tips, gratuities, service charges, up charges, etc. as specified by internal logic within the reservation server.

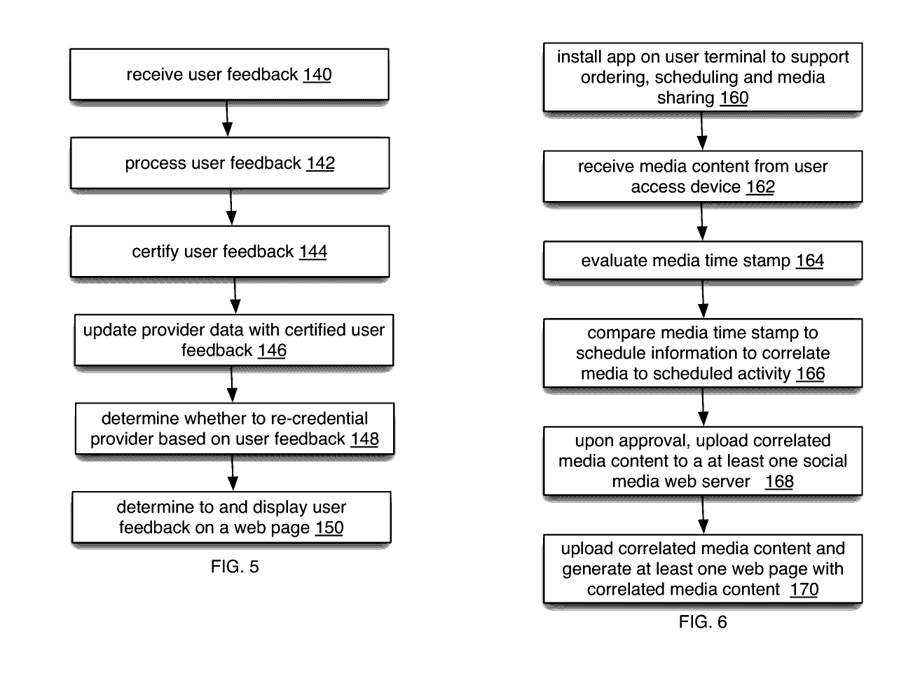

FIG. 5 is a flowchart that illustrates a method for capturing user feedback according to one embodiment. Referring now to FIG. 5, the method includes prompting the user to generate feedback and receiving user feedback (140). Thereafter, the method includes processing the user feedback (142). Processing to user feedback specifically includes a variety of steps including reviewing for validity, producing the data to the provider certification block and provider data storage block and providing the data to the advertising server. This step may also include receiving confirmation or approval from an individual prior to performing such processing. Thus, the method includes certifying the user feedback (144), updating provider data was certified user feedback (146), determining whether to re-credential provider based on the user feedback (148), and determining to and displaying the user feedback on a webpage, such as the advertising page or the providers personal page (150). This step may also include, for example, uploading the user feedback to a social media website for display in relation to either a service provider or an organization to which the service provider belongs or with which it affiliates.

FIG. 6 is a flowchart that illustrates a method for updating a social media website according to one embodiment. The method includes installing an app on a user access device or terminal to support ordering, scheduling and media sharing (160). Thereafter, the method includes receiving media content from the user access device (162). Thereafter, the method includes evaluating a timestamp of the media content (164) and comparing the media timestamp to schedule information to correlate the media to a scheduled activity (166). Thereafter, upon receiving approval, the method includes uploading the correlated media content to at least one social media Web server (168). The approval may be by the user, the provider, or other party as specified by internal logic within the reservation server and/or the app within the user access device. Thereafter, the method includes uploading the correlated media content and generating at least one webpage with the correlated media content (170).

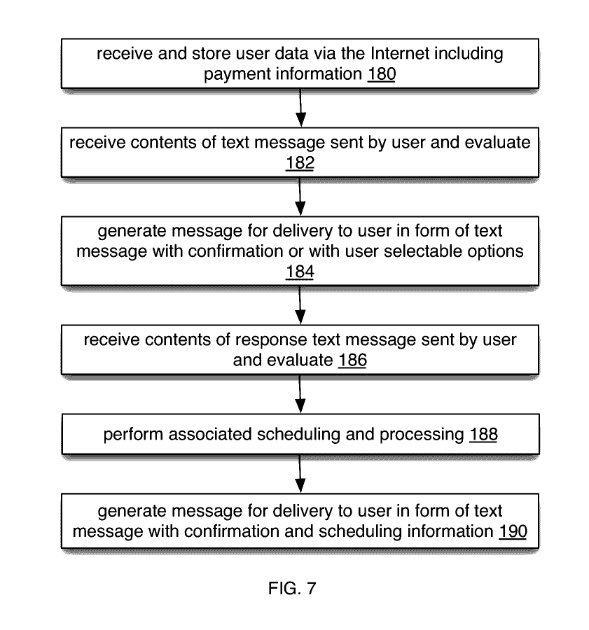

FIG. 7 is a flowchart that illustrates a method according to one embodiment utilizing text messaging to make reservations. The method commences with the reservation server receiving user data via the Internet including payment and account information (180). This step is a preliminary account set up type step. This step can include, for example, granting approval for the reservation server to generate binding reservations from a specified user access device that is text message capable. Thereafter, the method includes receiving contents of a text message sent by the user and evaluating (182). For example, a user may transmit a text message that is conducted within a text-messaging network and is delivered to a text-processing server that then delivers the contents of the text message to the reservation server. Alternatively, the reservation server may include text-messaging capability and may receive the text messages via a text-processing network directly. Thereafter, the method includes generating a message for delivery to the user in the form of the text message with confirmation or with user selectable options (184). Thereafter, the method includes either receiving a text message or receiving contents of a text message sent by the user and evaluating (186). Thereafter, the method includes performing associated scheduling and processing (188) and generating a message for delivery to the user in the form of a text message with confirmation and scheduling information. One point to be considered, is that this method of FIG. 7 lays out the basic steps for scheduling reservations via a text messaging system. All of the various aspects and embodiments described herein this document are implicitly included in the method of FIG. 7 though they are not specifically identified here.

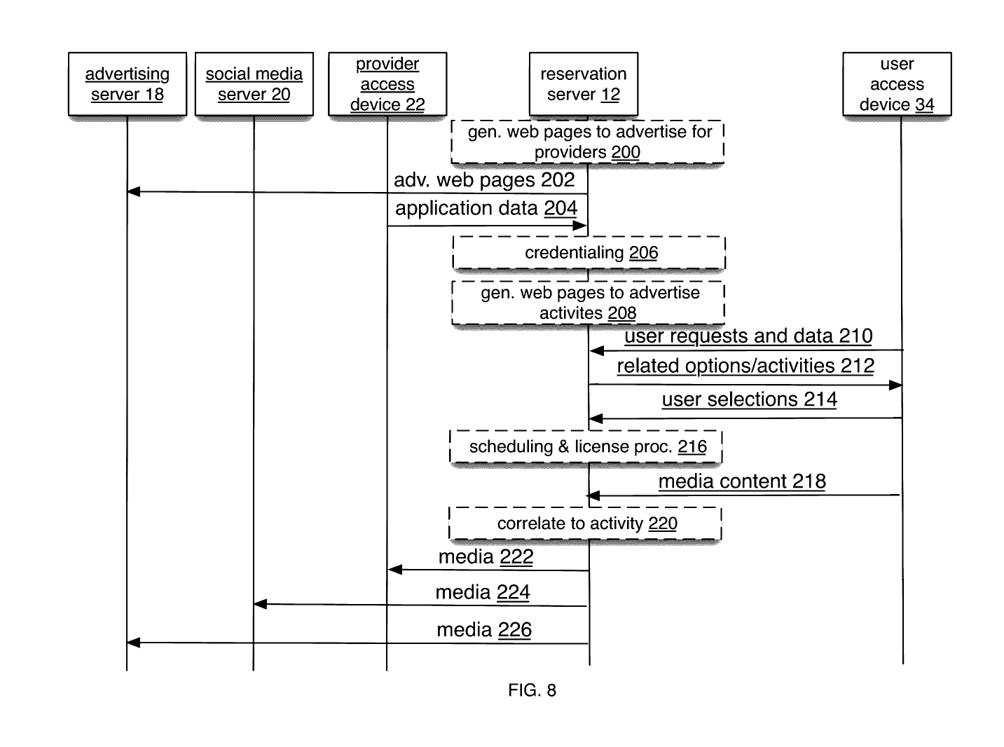

FIG. 8 is a signal flow diagram that illustrates a method according to one embodiment. As may be seen, the signal flow diagram of FIG. 8 includes a reservation server 12, provider access device 22, a social media server 20, and advertising server 18, and a user access device 34. The diagram of FIG. 8 is not limited to that number of devices but rather is intended to illustrate the overall process. Initially, the method commences with reservation server 12 generating webpage's to advertise for providers (200). The webpage's are then produced to advertising server 18 for display (202). Thereafter, a provider access device 22 produces application data to reservation server 12 (204). Based on the application data, reservation 12 then performs credentialing (206) and subsequently generates webpage's to advertise activities that include one or more of the credentialed providers (208). Thereafter, the method includes a user access device 34 transmitting user requests and data to reservation server 12 (210). Reservation server 12 then generates related options and activities to user device 34 (212). Thereafter, the method includes reservation server 12 receiving user selections from the user access device 34 (214). Thereafter, the method optionally includes the reservation server 12 performing scheduling and licensing processing (216). After the scheduled activity occurs, the method includes reservation server 12 receiving media content from user access device 34 or provider access device 22 (218). The method that then includes reservation server 12 correlating the received media content to an activity based on the schedule of activities and a timestamp of the media content (220). Finally, upon receiving appropriate approvals, the method includes reservation server 12 delivering the media content to provider access device 22 (222), social media server 20 (224), or advertising server 18 (226).

Generally, in an embodiment of a processor with memory, the memory or computer store contains data relating to lists of service providers, service provider schedules, service provider information, consumer data, feedback data, payment history, payment processing logic, service provider application data, service provider credentialing logic, scheduling logic, and preference data and logic for service providers and consumers, web page generation logic. A processor is configured to retrieve data and computer instructions that define operational logic to generate web pages, displays, data, and response processing. The computer and communication system thus includes communication circuitry and logic to define a web server configured to communicate with remote devices via the Internet.

The computer and communication system generates web pages and/or data to:
advertise for service providers and to receive service provider data applications;
advertise credentialed the services of credentialed service providers;
publish available schedules for service providers and activities;
receive payment for selected services;
list directly related, loosely related or indirectly related services, rentals, and licenses;
receive preferences and payments for the related services, rentals, and licenses;
receive consumer feedback regarding the activity, the service provider, and the related services, rentals, and licenses.

The processor of the computer and communication system retrieves the computer instructions and data from the computer store to:
populate the web pages with forms, graphics, video and data;
based on the received service provider data applications, analyze the service provider data applications to credential the service providers based on the application data;
schedule activities and track reservations for activities;
make related reservations for related services and rentals; and
process license applications and submit associated fees.

In operation, the computer and communication system is operable to create a presence on the world wide web in which a user may shop and schedule a plurality of services and items that are loosely or indirectly related in some cases and closely related in other cases but that may be things that a user would want. For example, if the service provider is a hunting guide, other items the user may be interested in include limousine services to and from an airport, car rental services, ammunition sales, licensing, lodging, entertainment, meal preparation, etc. Related service-processing module 24 is configured to generate a list of related options for the user to select based on the various services that are selected. Additionally, the user may want other types of guide services, for example, a fishing guide. In many cases, for example, a user may want to both fish and hunt on the same trip. For a fishing guide, the user may need to have bait delivered, may need to rent a boat, camping equipment, etc. Accordingly, one aspect is that the computer and communication system (e.g., related service and goods processing block 24) arranges and stores such related data and includes logic to generate offers on the web pages and social media for all of these unrelated, loosely related, and tightly related goods and services.

The computer and communication system includes logic and is operable to analyze service and goods provider applications to perform credentialing (e.g., memberships of organizations, licensed for the particular activity or service) to build the list of credentialed providers. The computer and communication system also includes schedule availability logic block 16 for maintaining a calendar of providers and the associated activities and of associated support (e.g., delivery of ordered items). As a part of this the computer and communication system includes scheduling logic 18 to make related reservations for services and other rentals (guns, tools, vehicles, etc.). Finally, the computer and communication system includes graphics logic 32 to generate graphical user interfaces (GUIs) to receive application data for associated licenses and to process license applications by submitted the license applications and associated fees to the corresponding authorities.

The computer and communication system of FIG. 2 is further configured to include logic such as pricing module 30 to support a negotiation process between providers and users and a payment processing module 28 that tracks all expenses for the selected goods and services and generates invoices and invoice estimates to the user.

The computer and communication system includes an app support block that, when the computer and communication system connects with a user device through a communication network to install an application that supports the reservation system operations. The app. support block also includes protocol communication logic to communicate with the user according to a protocol.

The app. that is delivered to the user device includes logic for transmitting media content (e.g., videos and pictures) taken during a scheduled event. The computer and communication system is configured and includes logic within a media-processing block for receiving media content and correlating the received media content to an activity. For example, media processing block evaluates a time stamp of the media content in relation to a scheduled time for an activity as indicated or stored by scheduling block 18 to determine if the media content was captured during the scheduled event. If so, the media-processing block produces the media content (after obtaining approval from necessary parties) to a remote device (e.g., one that hosts the provider specified social networking site or web page) to allow the provider to determine whether to approve the media content for display thereon. Furthermore, the media-processing block, upon receiving an indication of approval by the guide, generates a link that is transmitted to the user to allow the user to see his or her media content along with all other media content from other users that is posted on the web page or social networking site.

In one embodiment, the computer and communication system a text messaging block 38 to generate and process user selectable options via text messages. The computer and communication system utilizes a combination of user selections received in user generated text messages and user information stored in the computer store to schedule activities and related services, rentals, and licenses. For example, in one embodiment, user account information is stored in the computer store. Accordingly, when a received text message is correlated to a user via, for example, a phone number that generated the text, text-messaging block is operable to generate text messages to display selectable options, receive necessary information, and verify identity of the user sending the text messages.

Generally, a method is disclosed for a computer system useful in a reservation system that is configured to generate web pages offering activity related reservations and facilitation. The method includes storing user data and provider data in a memory store. This data, for the providers, includes data relating to lists of service providers, service provider schedules, service provider information, consumer data, feedback data, payment history, payment processing logic, service provider application data, service provider credentialing logic, scheduling logic, and preference data and logic for service providers and consumers, web page generation logic. For users, this data includes user preferences, payment and account information, history, feedback, and media content from activities among other types of data.

The method further includes storing operating instructions and web page generation information. Thereafter, the method includes retrieving the data and computer instructions that define operational logic to generate web pages, displays, data response processing and communication logic. This retrieved information then supports the next step of generating web pages to:
advertise for service providers and to receive service provider data applications;
advertise credentialed service providers and services;
publish available schedules for service providers and activities;
receive payment for selected services;
list related, loosely related and indirectly related services, rentals, and licenses;
receive preferences and payments for the related services, rentals, and licenses; and
receive consumer feedback regarding the activity, the service provider, and the related services, rentals, and licenses.

The method also includes retrieving and executing the computer instructions and data from the computer store to populate the web pages with forms, graphics and data. This includes web pages for receiving and processing provider applications. The logic defined by the computer instructions support processing the provider applications includes credentialing the providers to select only qualified providers that meet specified standards. With the pages that are generated for the users, the method includes receiving user preferences and selections. The method also includes displaying additional goods and services that the user may want.

Generally, the computer instructions define logic for, based on the received service provider data applications, analyzing the service provider data applications to credential the service providers based on the application data, schedule activities and track reservations for activities, making related reservations for related services and rentals.

The method includes receiving user feedback, receiving and correlating media to a scheduled activity. In response to the additional goods and services that were displayed, the method includes scheduling reservations for the additional goods and services that may be directly, loosely or indirectly related. The method also includes processing license applications and submitting associated fees.

The method also includes receiving media content and correlating the media content to a scheduled activity and populating social media sites with received media content. This method may include receiving approval from at least either the user or provider. In one embodiment, the method includes generating and processing text messages for scheduling activities and additional goods and services. This specifically includes generating text messages with selectable options and instructions, receiving text messages with user selections, processing text messages to verify user identity, and using text message relating to selectable related services, rentals, and licenses. The method further includes connecting with a user device and installing an application that supports the reservation system operations. Finally, the method includes utilizing a combination of text messaging and stored user data to schedule activities, rentals, license processing and purchases.

The above-disclosed subject matter is to be considered illustrative, and not restrictive, and the appended claims are intended to cover all such modifications, enhancements, and other embodiments that fall within the true scope of the claims. For example, there are many vertical markets that may utilize such a system. The system is beneficial for hunting and fishing activities as described herein. The system may also be used for coaching, tutoring, bicycle and hiking trips, and even for travel sites. Current web sites may list tightly coupled services (e.g., flight, hotel, auto), but are not configured to provide scheduling and support for other items including license processing, purchasing of various necessities, etc. that are loosely or indirectly related. For example, if a user seeks to reserve a guide for a fishing outing, a directly related service or good might be list boat rentals, bait supply, etc. A loosely related service or good might include a taxidermy service to mount fish that are caught. An indirectly related service might include a hunting guide (so the user can do both hunt and fish), spa services for a spouse, dog sitting services, etc.

In one embodiment, a method for a reservation system that includes at least one processor and memory with computer instructions for execution by the processor that, when executed by the processor, causes the processor to perform the steps of: generating a webpage that advertises goods and services; receiving user selections; and transmitting data or generating a subsequent webpage that includes directly related, loosely related, and indirectly related goods or services.

Additionally, the computer system may be configured to perform one or more of the steps of: receiving a text message indicating that a user desires to make a reservation; transmitting via text message at least one user selectable option; receiving via text message a user response; and scheduling and processing the user response and sending a confirmation to the user via text message.

A reservation system includes a server that generates advertisements for at least one of hunting guides, fishing guides, coaching, skiing guides, horseback riding guides, snowmobiling guides, and horseback riding guides; wherein the server is configured to receive a user selection; and when the server is configured to schedule according to the user selection. The reservation system may alternatively include a server that is configured to receive user selection for an advertised service; wherein the reservation system is configured to receive media content either from the user or a service provider; and wherein the reservation server is configured to correlate a timestamp of the media content to a scheduled event.

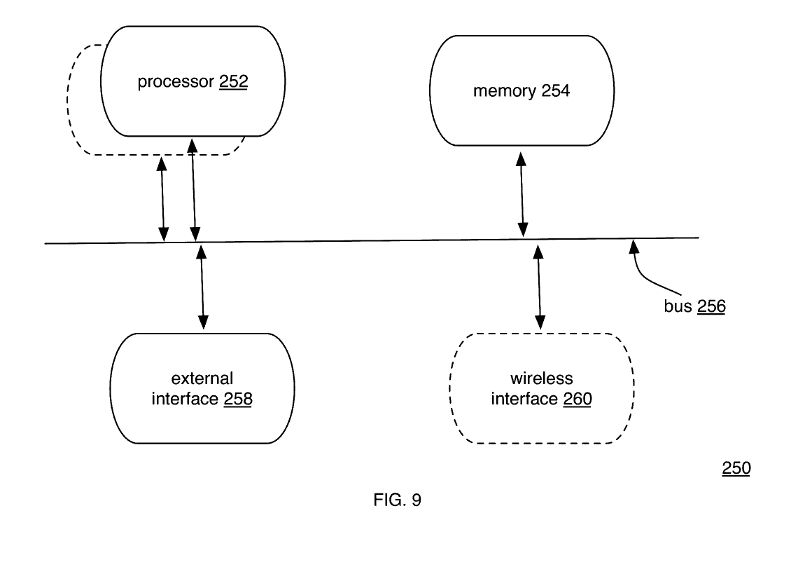

FIG. 9 is a functional block diagram of a processor system that represents a hardware configuration that may be modified by one of skill in the art to implement any element, module or block described herein this specification. More specifically, FIG. 9 is of a processor system 250 that includes one or more processors 252, a memory 254, a communication bus 256, external interface circuitry 258 and wireless interface circuitry 260. Processors 252, memory 254, bus 256, and interface circuitry 258 and 260 are configured and coupled to communicate over communications bus 256. Processor 252 retrieves computer instructions and data from memory 254 via bus 256 to execute the computer instructions to perform the method steps and operations described here in this specification. Referring back to FIG. 2, for example, the processor system 250 may be used to implement each individual block of FIG. 2 or alternatively, groups of blocks wherein the blocks represent functional elements created by processor 252 when executing computer instructions. The interface circuitry of FIG. 9 may also correspond to any of the blocks of FIG. 2 that perform communications.

Additionally, the blocks and circuit elements may be implemented with various combinations of hardware and software, and the software component may be stored in a computer readable storage medium for execution by at least one processor. Moreover the method illustrated may also be governed by instructions that are stored in a computer readable storage medium and that are executed by at least one processor. Each of the operations shown may correspond to instructions stored in a non-transitory computer memory or computer readable storage medium. In various embodiments, the non-transitory computer readable storage medium includes a magnetic or optical disk storage device, solid-state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

One aspect of the above described embodiments is that widgets (computer instructions) are written for distribution to various servers and/or computers (including handheld wireless devices) to support to functionality and operations described herein to facilitate an overall function that enhances services that may be provided to any one individual beyond what one person could typically receive at a vendor location. The widgets can be used on either other aggregator web sites, or on service providers to help ensure better, uniform tracking of sales and reservations. The widgets support capabilities that allow automatic matching of customer social media (or other) posts to reservations and distribute content to the correct channels and locations automatically. Some widgets optimize communication with service providers, due to the inability of the service providers to communicate with potential customers and/or payers for services. For example, one user complaint is that it is often very difficult to make reservations with service providers that are constantly outdoors with other customers (e.g., guides).

Other widgets support real time verification of service provider licenses and permits so that the customer can be sure that the activity that they are about to engage in is legal ahead of time. Many guides are not licensed, or do not have their credentials with them that are displayed.

Some widgets and computer processor executed code support the use multiple channels (email, voice and text) and have the computer translate between the two in order to facilitate communications and coordination between consumers and service providers, all, again, on a real time basis. Additional, another aspect of the widgets and embodiments of the invention is the capability to consolidate (automatically) content from multiple service providers based on user preferences (implied or explicit) to allow comparisons across multiple media in a single location. Moreover, the computer instructions operate with stored data to generate suggestions based on what has been learned about the user (and potentially his family) to make recommendations on activities that could be participated in which may otherwise be undiscovered and/or unknown to the consumer. Such suggestions and enable to purchase corresponding selectable options are often beyond the services provided by any one service or goods provider. For example, as one aspect of the embodiments of the invention, identification of additional services (such as licenses) that may augment activities, for example identifying a fishing license that may or may not be required depending on which service provider is used, and the location being fished based on local law (stored within a memory of a server) may be determined for a user that is geographically removed from the locale where the activity is to occur. For example, a user in Colorado may be in communication with a server in New York for a service in Louisiana. In the past, the user would have to be in communication with service providers in Louisiana to determine what local licensing and regulatory aspects are relevant.

Other aspects, possibly supported by widgets or other computer implemented routines including creating capabilities that provide automatic vetting or approving of service providers that which to become part of the offering based on an increasingly complex set of business rules (expanding to country, state or location specific). For a non-local service provider or consumer, such vetting that may be required would make it extremely difficult to accurately determine eligibility of either the customer or the service providers. Capabilities that allow service providers and/or specific service provider product/service offerings to be automatically withdrawn, for example, if a hunt season ends, any package with the species could be automatically withdrawn. This extends to help ensure compliance with laws of various jurisdictions such that when a law changes, business rules could be updated to manage availability of such products or services.

Availability of services can automatically be managed based on interfacing with other services (for example interface with NOAA to prevent fishing when there is an impending storm) by the embodiments described above. Such a system is configured to connect with licensing agencies to determine validity of licenses and permits automatically and limits service providers until conditions are corrected in some embodiments. Moreover, the embodiments and widgets support determining inter-relationships between services that a consumer would not know about, or would not be discoverable, such as, for example, renting a drone to video themselves skiing, where the drone rental is a completely separate company offering a completely unrelated service. This facilitates the expansion of offerings available that can be suggested automatically to consumers who would otherwise not know that said service exists. The various aspects of the embodiments of the invention thus include computer instructions to perform information searches and to coordinate activities in a more comprehensive than any one service provider in one location could or would feasibly be able to perform and to coordinate activities via computers in a way that individuals cannot.

The use of the same reference symbols in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer system useful in a reservation system that is configured to generate web pages and data offering activity related reservations and facilitation, the system comprising:
a computer store containing computer instructions and data relating to lists of guides, guide schedules, guide information, consumer data, feedback data, payment history, audio, images, video, logistical information, payment processing logic, guide application data, guide credentialing logic, scheduling logic, and preference data and logic for guides and consumers, web page generation logic;
a processor configured to retrieve data and computer instructions that define operational logic to generate web pages, displays, and data response processing and communication logic;
a web server configured to communicate with remote devices via the Internet;
wherein:
the computer system generates web pages to:
advertise for guides and to receive guide data applications;
advertise credentialed guides and services;
display images, video and audio;
publish available schedules for guides and activities;
receive payment for selected services;
list related, loosely related and indirectly related services, goods, rentals, and licenses;
receive preferences and payments for the related services, rentals, and licenses;
consumer feedback regarding the activity, the guide, and the related services, rentals, and licenses; and
wherein the processor retrieves the computer instructions and data from the computer store to:
populate the web pages with forms, graphics and data;
based on the received guide data applications, analyze and compare the guide data applications to credential the guides based on the application data;
schedule activities and track reservations for activities;
make related reservations for related services and rentals; and
process license applications and submit associated fees.

2. The computer system of claim 1 wherein the computer system connects with a user device to install an application that supports the reservation system operations.

3. The computer system of claim 2 wherein the computer system receives media content and/or data from the user device.

4. The computer system of claim 2 wherein the computer system receives media content and/or data and correlates the media content to a scheduled activity.

5. The computer system of claim 4 wherein the computer system uploads the received media content and/or data to at least one social media site.

6. The computer system of claim 4 wherein the computer system uploads the received media content and/or data to at least one social media site after receiving approval from one of the activity guide or the activity customer.

7. The computer system of claim 1 where the computer system generates a text message with selectable activity options and transmits the text message to a user.

8. The computer system of claim 1 where the computer system receives a user generated text message with selected activity options.

9. The computer system of claim 1 where the computer system schedules activities based on the received user generated text message with selected activity options.

10. The computer system of claim 1 where the computer system generates a text message with selectable related services, rentals, and licenses.

11. The computer system of claim 10 where the computer system utilizes a combination of user selections received in the user generated text message and user information stored in the computer store to schedule activities and related services, rentals, and licenses.

12. A computer system useful in a reservation system that is configured to generate web pages offering activity directly, loosely or indirectly related reservations and facilitation, the system comprising:
a computer store containing data relating to lists of service providers, service provider schedules, service provider information, consumer data, feedback data, payment history, payment processing logic, service provider application data, service provider credentialing logic, scheduling logic, and preference data and logic for service providers and consumers, audio, images, video content, and web page generation logic;
a processor configured to retrieve data and computer instructions that define operational logic to generate web pages, displays, and data response processing and communication logic;
a web server configured to communicate with remote devices via the Internet;
wherein:
the computer system generates web pages to:
advertise for service providers and to receive service provider data applications;
advertise credentialed service providers and services;
publish available schedules for service providers and activities;
receive payment for selected services;
list directly, loosely and indirectly related services, rentals, and licenses;
receive preferences and payments for the related services, rentals, and licenses;
consumer feedback regarding the activity, the service provider, and the related services, rentals, and licenses; and
wherein the processor retrieves the computer instructions and data from the computer store to:
populate the web pages with forms, graphics and data;
based on the received service provider data applications, analyze the service provider data applications to credential the service providers based on the application data;
schedule activities and track reservations for activities;
make related reservations for related services and rentals; and
process license applications and submit associated fees.

13. The computer system of claim 12 wherein the computer system connects with a user device to install an application that supports the reservation system operations.

14. The computer system of claim 13 wherein the computer system receives media content and/or data from the user device.

15. The computer system of claim 13 wherein the computer system receives media content and/or data and correlates the media content to a scheduled activity.

16. The computer system of claim 15 wherein the computer system uploads the received media content and/or data to at least one social media site.

17. The computer system of claim 15 wherein the computer system uploads the received media content and/or data to at least one social media site after receiving approval from one of the activity service provider or the activity customer.

18. The computer system of claim 12 where the computer system generates a text message with selectable activity options and transmits the text message to a user.

19. The computer system of claim 12 where the computer system receives a user generated text message with selected activity options.

20. The computer system of claim 12 where the computer system schedules activities based on the received user generated text message with selected activity options.

21. The computer system of claim 12 where the computer system generates a text message with selectable related services, rentals, and licenses.

22. The computer system of claim 21 where the computer system utilizes a combination of user selections received in the user generated text message and user information stored in the computer store to schedule activities and related services, rentals, and licenses.

23. A method for a computer system useful in a reservation system that is configured to generate web pages offering activity related reservations and facilitation, the method comprising:
storing data in a memory store relating to lists of service providers, service provider schedules, service provider information, consumer data, feedback data, payment history, payment processing logic, service provider application data, service provider credentialing logic, scheduling logic, and preference data and logic for service providers and consumers, web page generation logic;
retrieving the data and computer instructions that define operational logic to generate web pages, displays, and data response processing and communication logic;
generating web pages to:
advertise for service providers and to receive service provider data applications;
advertise credentialed service providers and services;
publish available schedules for service providers and activities;
receive payment for selected services;
list directly, loosely and indirectly related services, rentals, and licenses;
receive preferences and payments for the related services, rentals, and licenses;
receive consumer feedback regarding the activity, the service provider, and the related services, rentals, and licenses; and
retrieving and executing the computer instructions and data from the computer store to:
populate the web pages with forms, graphics and data;
based on the received service provider data applications, analyze the service provider data applications to credential the service providers based on the application data;
schedule activities and track reservations for activities;
make related reservations for related services and rentals; and
process license applications and submit associated fees.

24. The method of claim 23 further including connecting with a user device and installing an application that supports the reservation system operations.

25. The method of claim 24 further including receiving media content and/or data from the user device.

26. The method of claim 24 further including receiving media content and/or data and correlating the media content and/or data to a scheduled activity.

27. The method of claim 26 further including uploading the received media content and/or data to at least one social media site.

28. The method of claim 26 further including uploading the received media content to at least one social media site after receiving approval from one of the activity service provider or the activity customer.

29. The method of claim 23 further including generating a text message with selectable activity options and transmits the text message to a user.

30. The method of claim 29 further including receiving a user generated text message with selected activity options.

31. The method of claim 30 scheduling activities based on the received user generated text message with selected activity options.

32. The method of claim 29 further including generating a text message with selectable related services, rentals, and licenses.

33. The method of claim 32 further including utilizing a combination of user selections received in the user generated text message and user information stored in the computer store to schedule activities and related services, rentals, and licenses.
